(19) United States
(12) Patent Application Publication
(10) Pub. No.: US 2011/0063253 A1
(43) Pub. Date: Mar. 17, 2011

(54) OPTICAL POSITION DETECTOR AND DISPLAY DEVICE WITH POSITION DETECTION FUNCTION

(75) Inventor: Kanechika Kiyose, Matsumoto (JP)

(73) Assignee: SEIKO EPSON CORPORATION, Tokyo (JP)

(21) Appl. No.: 12/852,547

(22) Filed: Aug. 9, 2010

(30) Foreign Application Priority Data
Sep. 17, 2009 (JP) 2009-215380

(51) Int. Cl. G06F 3/042; G06M 7/00

(52) U.S. Cl. 345/175; 250/221

(57) ABSTRACT

An optical position detector for optically detecting a position of a target object within a detection area, includes: a position-detecting light source unit that emits a position detection light toward the detection area to form an intensity distribution of the position detection light in the detection area; a plurality of light detectors with their central optical axes directed to different areas from each other within the detection area; and a signal processing unit that detects a position of the target object based on the result of receiving, by the plurality of light detectors, the position detection light reflected by the target object in the detection area.

### BACKGROUND

1. Technical Field

The present invention relates to an optical position detector that optically detects a position of a target object within a detection area and a display device with a position detection function including the optical position detector.

2. Related Art

In electronic apparatuses such as mobile phones, car navigation systems, personal computers, ticket-vending machines, and bank terminals, a display device with a position detection function in which a touch panel is arranged in front of an image forming device such as a liquid crystal device has been recently used. In the display device with a position detection function, input of information is performed with reference to an image displayed on the image forming device. Such a touch panel is configured as a position detector that detects a position of a target object within a detection area (for example, refer to U.S. Pat. No. 6,927,384).

A position detector described in U.S. Pat. No. 6,927,384 is of the optical type, in which a light guide plate is disposed on an input operation side with respect to a direct-view type display panel such as a liquid crystal panel, and a light source, a light-receiving element, and the like are arranged on the opposite side to the input operation side with respect to the light guide plate. A position detection light emitted from the light source is emitted to the input operation side via the light guide plate, and the position detection light reflected by a target object is received by the light-receiving element.

Here, the present inventor proposes, by applying the structure described in U.S. Pat. No. 6,927,384, an optical position detector schematically shown in FIGS. 14A and 14B. In the optical position detector having the configuration, an intensity distribution of a position detection light is formed in an in-plane direction of a detection area 10R, and the position detection light reflected by a target object Ob in the detection area 10R is detected by alight detector 15. For example, a light intensity distribution of the position detection light emitted from a light guide plate 13 to the detection area 10R is different between when a position detection light L2a is emitted from a position-detecting light source 12A and when a position detection light L2b is emitted from a position-detecting light source 12B. Accordingly, when the received-light results by the light detector 15 are compared between when the position detection light L2a is emitted and when the position detection light L2b is emitted, a position of the target object Ob in a direction indicated by the arrows A can be detected. Moreover, when the received-light results by the light detector 15 are compared between when a position detection light L2c is emitted from a position-detecting light source 12C and when a position detection light L2d is emitted from a position-detecting light source 12D, a position of the target object Ob in a direction indicated by the arrows B can be detected.

However, the optical position detector having the configuration shown in FIGS. 14A and 14B has a problem in that, although position detection can be performed with high accuracy when the target object Ob is positioned at the central portion of the detection area 10R, the detection accuracy is decreased when the target object Ob is positioned at an edge of the detection area 10R. As a result of studying the problem, the present inventor has found that the decrease in detection accuracy when the target object Ob is positioned at an edge of the detection area 10R is caused by the influence of sensitivity directivity of the light detector 15. That is, the light detector 15 has high sensitivity in a predetermined angle range but has low sensitivity in an angular direction far away from its central optical axis. Therefore, not only the intensity distribution of the position detection light but also the sensitivity directivity of the light detector 15 greatly affect the detection result by the light detector 15. It should be noted that the embodiment shown in FIGS. 14A and 14B is a reference example of the invention but is not a related art.

### SUMMARY

An advantage of some aspects of the invention is to provide an optical position detector that can be less subject to sensitivity directivity of a light detector even when position detection is performed using an intensity distribution of a position detection light within a detection area, and a display device with a position detection function including the optical position detector.

A first aspect of the invention is directed to an optical position detector for optically detecting a position of a target object within a detection area, including: a position-detecting light source unit that emits a position detection light toward the detection area to form an intensity distribution of the position detection light in the detection area; a plurality of light detectors with their central optical axes directed to different areas from each other within the detection area; and a signal processing unit that detects a position of the target object based on the result of receiving, by the plurality of light detectors, the position detection light reflected by the target object in the detection area.

In the first aspect of the invention, the intensity distribution of the position detection light is formed in an in-plane direction of the detection area, and the position detection light reflected by the target object in the detection area is detected by the light detectors. In this case, the light detectors are used in plural numbers, and the plurality of light detectors have central optical axes directed to different areas from each other of the detection area. Accordingly, even when the light detector has sensitivity directivity, the detection area can be covered only with respective high-sensitivity angle ranges of the plurality of light detectors. Therefore, even when position detection is performed using the intensity distribution of the position detection light within the detection area, the position detection is less subject to the sensitivity directivity of the light detectors.

In the first aspect of the invention, it is preferable that the plurality of light detectors are arranged at a specified place adjacent to a side portion of the detection area with the central optical axes directed in different angular directions from each other. According to the configuration, the plurality of light detectors can be arranged in a narrow space around the detection area.

In this case, it is preferable that the plurality of light detectors include three or more light detectors with central optical axes equally angularly spaced. When the central optical axes are equally angularly spaced, the respective high-sensitivity angle ranges of the plurality of light detectors can be effectively utilized.

In the first aspect of the invention, the plurality of light detectors may be configured such that the plurality of light detectors are arranged in an identical side portion of the detection area at positions shifted in an extending direction of the side portion with the central optical axes directed in a direction parallel to each other.

In the first aspect of the invention, it is preferable that the light detector includes a light-receiving element including a light-receiving portion, and a directivity adjusting member that reduces a difference between an incident light amount on a central optical axis side of the light-receiving element and an incident light amount in an angular direction away from the central optical axis. With such a configuration, even when sensitivity directivity exists in a high-sensitivity angle range in the light detector, sensitivity can be equalized by the directivity adjusting member. Therefore, the position detection accuracy can be enhanced.

In the first aspect of the invention, as the directivity adjusting member, a light shielding member that causes a light incident opening to become narrower on the central optical axis side of the light-receiving element than in an angular direction away from the central optical axis can be used. With such a configuration, the sensitivity directivity within the high-sensitivity angle range in the light detector can be moderated with the simple configuration that the size of the light incident opening is increased or decreased. Therefore, the position detection accuracy can be enhanced.

In this case, it is preferable that the light shielding member includes as the light incident opening a slit that extends from the central optical axis side of the light-receiving element toward an angular direction side away from the central optical axis, and that a width dimension of the slit on the central optical axis side is narrower than a width dimension of the slit in an angular direction away from the central optical axis. When the light incident opening is formed as a slit, the sensitivity directivity within the high-sensitivity angle range can be properly eliminated in the light detector by changing the slit width continuously or stepwise. Therefore, the position detection accuracy can be enhanced.

In the first aspect of the invention, it is preferable that the signal processing unit includes a received-light intensity-determining section that determines absolute magnitude of received-light intensities by the plurality of light detectors or relative magnitude of received-light intensities by the plurality of light detectors, and a position detection section that detects a position of the target object based on, of received-light results by the plurality of light detectors, a received-light result by a light detector determined as having a higher received-light intensity in the determination result by the received-light intensity-determining section. With such a configuration, a position of the target object can be detected only using the received-light result by a light detector close to the target object of the plurality of light detectors.

A second aspect of the invention is directed to, for example, a display device with a position detection function including the optical position detector to which the first aspect of the invention is applied. In this case, the display device with a position detection function has an image forming device that forms an image in an area overlapping the detection area.

The display device with a position detection function according to the second aspect of the invention is used not only for various display devices such as projection type display devices but also for electronic apparatuses such as mobile phones, car navigation systems, personal computers, ticket-vending machines, and bank terminals.

### BRIEF DESCRIPTION OF THE DRAWINGS

The invention will be described with reference to the accompanying drawings, wherein like numbers reference like elements.

FIGS. 1A and 1B are explanatory views schematically showing the configuration of a display device with a position detection function to which the invention is applied.

FIGS. 2A to 2C are explanatory views and a graph showing the basic configuration of an optical position detector to which the invention is applied.

FIG. 3 is a graph showing sensitivity directivity of a photodiode used for a light detector in the optical position detector to which the invention is applied.

FIG. 4 is an explanatory view showing the configuration of the light detector and a signal processing unit used for the optical position detector to which the invention is applied.

FIGS. 5A to 5D are explanatory views of the light detector used for the optical position detector to which the invention is applied.

FIG. 6 is an explanatory view showing a modified example of the signal processing unit used for the optical position detector to which the invention is applied.

FIGS. 7A and 7B are explanatory views of another position-detecting light source unit used for the optical position detector to which the invention is applied.

FIG. 8 is an explanatory view of another position-detecting light source unit used for the optical position detector to which the invention is applied.

FIG. 9 is an exploded perspective view of an optical position detector and a display device with a position detection function according to a first modified example of the invention.

FIG. 10 is an explanatory view showing the cross-sectional configuration of the optical position detector and the display device with a position detection function according to the first modified example of the invention.

FIG. 11 is an exploded perspective view of an optical position detector and a display device with a position detection function according to a second modified example of the invention.

FIGS. 12A and 12B are an explanatory view showing a cross-sectional configuration and a graph, respectively, of the optical position detector and the display device with a position detection function according to the second modified example of the invention.

FIGS. 13A to 13C are explanatory views of electronic apparatuses using the display device with a position detection function according to the invention.

FIGS. 14A and 14B are explanatory views of an optical position detector according to a reference example of the invention.

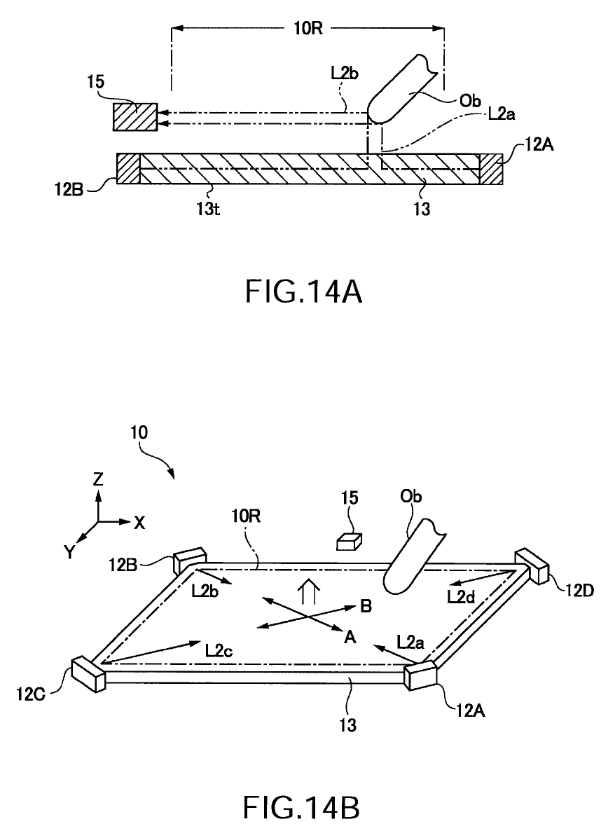

### DESCRIPTION OF EXEMPLARY EMBODIMENTS

Embodiments of the invention will be described in detail with reference to the accompanying drawings. In the following description, an in-plane direction within a detection area is defined as an XY plane in an XYZ orthogonal coordinate, while a direction orthogonal to the in-plane direction within the detection area is defined as a Z-axis direction.

Configuration of Optical Position Detector and Display Device with Position Detection Function
Overall Configuration of Display Device with Position Detection Function

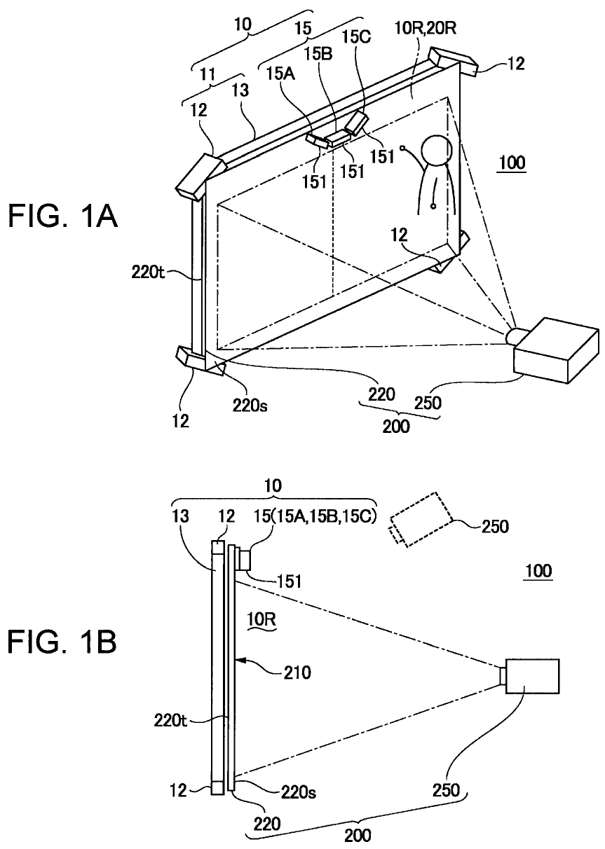

FIGS. 1A and 1B are explanatory views schematically showing the configuration of a display device with a position detection function to which the invention is applied, in which FIG. 1A is an explanatory view schematically showing the main part of the display device with a position detection function as viewed obliquely from above; and FIG. 1B is an explanatory view schematically showing the same as viewed from the side.

The display device with a position detection function 100 shown in FIGS. 1A and 1B includes an optical position detector 10 and an image forming device 200. The optical position detector 10 detects, when a target object Ob such as a finger approaches a detection area 10R based on an image displayed by the image forming device 200, a planar position (X-coordinate position and Y-coordinate position) of the target object Ob.

As will be described in detail later, the optical position detector 10 has a position-detecting light source unit 11 including a plurality of position-detecting light sources 12 each emitting a position detection light formed of an infrared light, and a light detector 15 having light-receiving portions 151 each directed to the detection area 10R. In the embodiment, the position-detecting light source unit 11 also includes a light guide plate 13 disposed parallel to the XY plane. The light detector 15 includes a light-receiving element such as a photodiode or a phototransistor.

In the embodiment, the image forming device 200 is of the projection type and has a screen member 220 disposed on a front side (input operation side) of the light guide plate 13 in an overlapped manner and an image projector 250 that projects a display light in an enlarged manner on one surface 220s side of the screen member 220. The image forming device 200 has an image display area 20R on the screen member 220. On the one surface 220s side where the image projector 250 is positioned with respect to the screen member 220, the detection area 10R of the optical position detector 10 is positioned, while on the other surface 220t side of the screen member 220, the position-detecting light source unit 11 including the light guide plate 13 and the position-detecting light sources 12 is arranged. In the embodiment, the image display area 20R is an area substantially overlapping the detection area 10R.

In the embodiment, various kinds of those described below can be used for the screen member 220. Any of those is formed of a material capable of transmitting an infrared light. First, as the screen member 220, a white screen formed of a cloth having a surface coated with white paint or an embossed white vinyl material can be used. Moreover, as the screen member 220, a silver screen having high silver color for increasing the light reflectance can be used. Further, as the screen member 220, a pearl screen having a resinated cloth surface for increasing the light reflectance or a beads screen having a surface coated with fine glass powders for increasing the light reflectance can be used. The screen member 220 is configured as a manual hanging screen with a light-receiving element or a motorized screen with a light-receiving element.

Although FIGS. 1A and 1B show the example in which the image projector 250 is arranged in front of the screen member 220, the image projector 250 sometimes obliquely provides a display light toward the screen member 220 as shown by dashed-dotted lines in FIG. 1B.

### Basic Configuration of Optical Position Detector 10

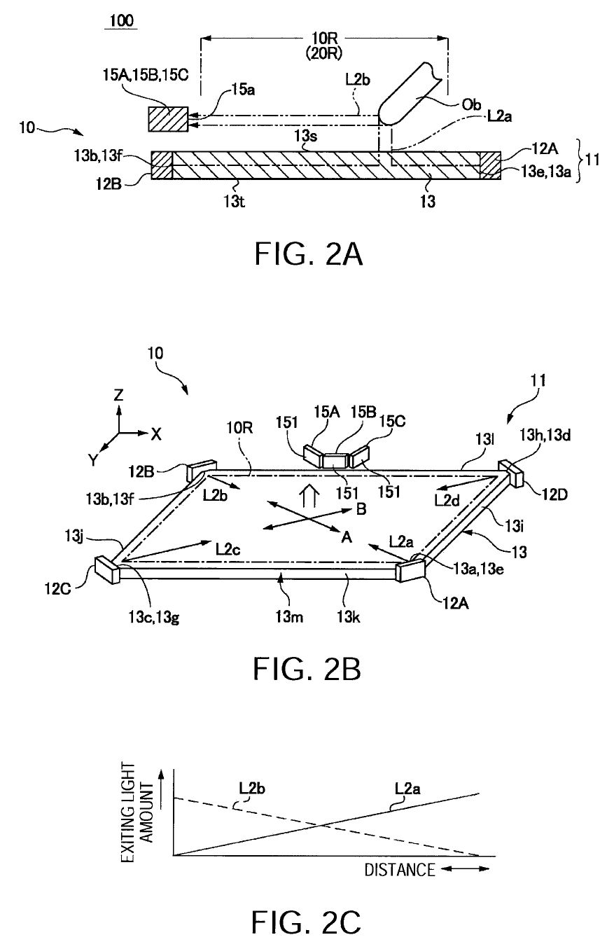

FIGS. 2A to 2C are explanatory views and a graph showing the basic configuration of the optical position detector 10 to which the invention is applied, in which FIG. 2A is an explanatory view schematically showing the cross-sectional configuration of the optical position detector 10; FIG. 2B is an explanatory view showing the configuration of the light guide plate 13 and the like used for the optical position detector; and FIG. 2C is a graph showing the attenuation condition of a position-detecting infrared light within the light guide plate 13. In FIGS. 2A to 2C, the Z-axis direction is the vertical direction.

As shown in FIGS. 2A and 2B, in the optical position detector 10 of the embodiment, the position-detecting light source unit 11 includes the light guide plate 13 having substantially a rectangular planner shape. At a side edge surface 13m of the light guide plate 13, side portions 13k and 13l corresponding to long sides face each other in a Y-axis direction, and side portions 13i and 13j corresponding to short sides face each other in an X-axis direction. According to the shape of the light guide plate 13, the optical position detector 10 has four position-detecting light sources 12A to 12D (the position-detecting light sources 12 shown in FIGS. 1A and 1B) emitting position detection lights L2a to L2d. The light guide plate 13 includes at the side edge surface 13m four light incident portions 13a to 13d on which the position detection lights L2a to L2d are incident. The light guide plate 13 includes at one surface (upper surface in the drawing) a light exiting surface 13s from which the position detection lights L2a to L2d propagating through the inside of the light guide plate 13 exit. The light exiting surface 13s and the side edge surface 13m are orthogonal to each other. The optical position detector 10 includes the light detector 15 (light detectors 15A, 15B, and 15C) having the light-receiving portion 151 directed to the detection area 10R.

In the embodiment, both the four position-detecting light sources 12A to 12D and the four light incident portions 13a to 13d are disposed at corner portions 13e, 13f, 13g, and 13h of the light guide plate 13. The position-detecting light sources 12A to 12D are arranged so as to face the light incident portions 13a to 13d and preferably arranged so as to be in close contact with the light incident portions 13a to 13d.

The light guide plate 13 is formed of a transparent resin plate such as polycarbonate or acrylic resin. In the light guide plate 13, a surface asperity structure, a prism structure, a scattering layer (all not shown), and the like are disposed on the light exiting surface 13s or a back surface 13t on the opposite side of the light exiting surface 13s. With such a light scattering structure, the light incident from the light incident portions 13a to 13d to propagate through the inside of the light guide plate is gradually deflected as it progresses in its propagation direction and exits from the light exiting surface 13s. On the light exiting side of the light guide plate 13, an optical sheet such as a prism sheet or a light scatter is sometimes arranged as necessary for equalizing the position detection lights L2a to L2d.

The position-detecting light sources 12A to 12D each include a light-emitting element such as a light-emitting diode (LED) and emit as diverging light the position detection lights L2a to L2d formed of an infrared light in response to a drive signal output from a drive circuit (not shown). The kinds of the position detection lights L2a to L2d are not particularly limited, but the position detection lights L2a to L2d may be different in wavelength distribution from a visible light or may be different in light-emitting mode therefrom by adding modulation such as flashing. The position detection lights L2a to L2d preferably have a wavelength band in which the light is effectively reflected by the target object Ob such as a finger or a touch pen. Accordingly, when the target object Ob is a human body such as a finger, it is desirable that the position detection light is an infrared ray (especially a near infrared ray close to the visible light range, for example, close to a wavelength of 850 nm) that has a high reflectance for the surface of a human body, or has a wavelength of 950 nm.

The position-detecting light sources 12A to 12D are disposed essentially in plural numbers and configured so as to emit the position detection lights L2a to L2d from different positions from one another. Of the four position-detecting light sources 12A to 12D, the position-detecting light sources at diagonal positions are paired to form a first light source, and the other two position-detecting light sources are paired to form a second light source. Of the four position-detecting light sources 12A to 12D, the neighboring two position-detecting light sources are paired to form a first light source pair, and the other two position-detecting light sources are paired to form a second light source pair, in some cases.

The detection area 10R is a planar area where the position detection lights L2a to L2d are emitted to a viewing side (operation side) and the reflected light can be generated by the target object Ob. In the embodiment, the planar shape of the detection area 10R is a rectangle in which the light detector 15 (the light detectors 15A, 15B, and 15C) is arranged substantially at the central portion, in a length direction, of one side portion of the four side portions. In the detection area 10R, the inner angle of the corner portion formed by adjacent sides is 90 degrees, which is the same angle as the inner angle of the corner portions 13e to 13h of the light guide plate 13.

In the thus configured display device with a position detection function 100, the position detection light L2a and the position detection light L2b exit from the light exiting surface 13s while counterpropagating through the inside of the light guide plate 13 in a direction indicated by the arrows A. The position detection light L2c and the position detection light L2d exit from the light exiting surface 13s while counterpropagating in a direction (direction indicated by the arrows B) crossing the direction indicated by the arrows A. Accordingly, the light amount of the position detection light L2a exiting from the light guide plate 13 toward the detection area 10R has an intensity distribution that linearly declines with the distance from the position-detecting light source 12A as indicated by a solid line in FIG. 2C. The light amount of the position detection light L2b exiting toward the detection area 10R has an intensity distribution that linearly declines with the distance from the position-detecting light source 12B as indicated by a dotted line in FIG. 2C.

### Basic Principle for Detecting XY Coordinates

A method of obtaining XY coordinates of the target object Ob based on the detection by the light detector 15 will be described. Various obtaining methods of the position information are conceivable. For example, one example is a method of determining the ratio of attenuation coefficients based on the ratio of the detected light amounts of two position detection lights and determining the propagation distances of both the position detection lights based on the ratio of the attenuation coefficients to determine a position coordinate in a direction connecting the two corresponding light sources. Another example is a method of determining the difference of the detected light amount between two position detection lights and determining, based on the difference, a position coordinate in a direction connecting the two corresponding light sources. Any of the methods includes a method of using the output value from the light detector 15 as it is for calculation and a method of using, for calculation, the time until the voltage across terminals of a capacitor reaches a predetermined voltage by causing the capacitor to store charge or discharge via the light detector 15. Any of the cases uses the nature described below.

In the display device with a position detection function 100, the position detection lights L2a to L2d emitted from the position-detecting light sources 12A to 12D respectively enter the inside of the light guide plate 13 from the light incident portions 13a to 13d and gradually exit from the light exiting surface 13s while propagating through the inside of the light guide plate 13. As a result, the position detection lights L2a to L2d exit from the light exiting surface 13s in a planar manner.

For example, the position detection light L2a gradually exits from the light exiting surface 13s while propagating through the inside of the light guide plate 13 from the light incident portion 13a toward the light incident portion 13b. Similarly, the position detection lights L2c and L2d gradually exit from the light exiting surface 13s while propagating through the inside of the light guide plate 13. Accordingly, when the target object Ob such as a finger is arranged in the detection area 10R, the position detection lights L2a to L2d are reflected by the target object Ob, and portion of the reflected light is detected by the light detector 15.

In this case, it is considered that the light amount of the position detection light L2a emitted to the detection area 10R linearly declines with the distance from the position-detecting light source 12A as indicated by the solid line in FIG. 2C, and that the light amount of the position detection light L2b emitted to the detection area 10R linearly declines with the distance from the position-detecting light source 12B as indicated by the dotted line in FIG. 2C.

When the control amount (for example, current amount), conversion coefficient, and emitting light amount of the position-detecting light source 12A are Ia, k, and Ea respectively, and the control amount (current amount), conversion coefficient, and emitting light amount of the position-detecting light source 12B are Ib, k, and Eb respectively, the following equations are given.

Ea=k·Ia

Eb=k·Ib

When the attenuation coefficient and detected light amount of the position detection light L2a are fa and Ga respectively, and the attenuation coefficient and detected light amount of the position detection light L2b are fb and Gb respectively, the following equations are given.

Ga=fa·Ea=fa·k·Ia

Gb=fb·Eb=fb·k·Ib

Accordingly, if Ga/Gb, which is the ratio of the detected light amounts of both the position detection lights, can be detected in the light detector 15, the following equation is given.

Ga/Gb=(fa·Ea)/(fb·Eb)=(fa/fb)·(Ia/Ib)

Therefore, when the values corresponding to the ratio Ea/Eb of the emitting light amounts and the ratio Ia/Ib of the control amounts are known, the ratio fa/fb of the attenuation coefficients can be known. If there is a linear relation between the ratio of the attenuation coefficients and the ratio of the propagation distances of both the position detection lights, the position information of the target object Ob can be obtained by previously setting the linear relation.

As a method of determining the ratio fa/fb of the attenuation coefficients, for example, the position-detecting light source 12A and the position-detecting light source 12B are caused to flash out of phase (for example, drive signals having a rectangular waveform or a sine waveform are operated so as to be 180 degrees of phase difference with each other at a frequency at which a phase difference caused by the difference of propagation distance is negligible), and the waveform of the detected light amount is analyzed. More realistically, for example, one control amount Ia is fixed (Ia=Im), the other control amount Ib is controlled so that the waveform to be detected cannot be observed, that is, so that the ratio Ga/Gb of the detected light amounts becomes 1, and the ratio fa/fb of the attenuation coefficients is derived from the control amount Ib=Im·(fa/fb) at this time.

Moreover, the control amounts may be controlled so that the sum of both the control amounts is always constant, that is, so as to satisfy the following equation.

Im=Ia+Ib

In this case, the following equation is given.

Ib=Im·fa/(fa+fb)

Therefore, assuming that fa/(fa+fb)=α, the ratio of attenuation coefficients is determined by the following equation.

fa/fb=α/(1−α)

Accordingly, the position information of the target object Ob in the arrow A direction can be obtained by driving the position-detecting light source 12A and the position-detecting light source 12B out of phase with each other. The position information of the target object Ob in the arrow B direction can be obtained by driving the position-detecting light source 12C and the position-detecting light source 12D out of phase with each other. Therefore, the position coordinates of the target object Ob on the XY plane can be obtained by sequentially performing the detection operation in the direction A and the direction B in a control system.

As described above, for obtaining the planar position information of the target object Ob within the detection area 10R based on the light amount ratio of the position detection lights detected by the light detector 15, a configuration can be employed in which, for example, a microprocessing unit (MPU) is used as a signal processing unit by which processing is performed according to the execution of predetermined software (operation program). Also a configuration can be employed in which processing is performed with a signal processing unit using hardware such as a logic circuit. Such a signal processing unit may be incorporated as a part of the display device with a position detection function 100 or may be configured in an electronic apparatus on which the display device with a position detection function 100 is mounted.

### Detecting Method of Embodiment

For detecting the X-coordinate position of the target object Ob in the detection area 10R in the optical position detector 10 of the embodiment, the position-detecting light sources 12A and 12D are driven in phase, the position-detecting light sources 12B and 12C are driven in phase, and the position-detecting light sources 12A and 12D and the position-detecting light sources 12B and 12C are driven out of phase. That is, a first period during which the position-detecting light sources 12A and 12D are turned on, and the position-detecting light sources 12B and 12C are turned off, to form an intensity distribution having a high exiting intensity in one direction of the X-axis direction, and a second period during which the position-detecting light sources 12B and 12C are turned on, and the position-detecting light sources 12A and 12D are turned off, to form an intensity distribution having a high exiting intensity in the other direction of the X-axis direction, are alternately set. Accordingly, by using the ratio or difference of the detected value of the light detector 15 between the first period and the second period in a later-described signal processing unit, the X coordinate of the target object Ob in the detection area 10R can be detected.

For detecting the Y-coordinate position of the target object Ob in the detection area 10R, the position-detecting light sources 12A and 12C are driven in phase, the position-detecting light sources 12B and 12D are driven in phase, and the position-detecting light sources 12A and 12C and the position-detecting light sources 12B and 12D are driven out of phase. That is, a first period during which the position-detecting light sources 12A and 12C are turned on, and the position-detecting light sources 12B and 12D are turned off, to form an intensity distribution having a high exiting intensity in one direction of the Y-axis direction, and a second period during which the position-detecting light sources 12B and 12D are turned on, and the position-detecting light sources 12A and 12C are turned off, to form an intensity distribution having a high exiting intensity in the other direction of the Y-axis direction, are alternately set. Accordingly, by using the ratio or difference of the detected value of the light detector 15 between the first period and the second period in a position detection section of the signal processing unit, the Y coordinate of the target object Ob in the detection area 10R can be detected.

Here, the detection of the Z coordinate may be performed by causing the four position-detecting light sources 12A to 12D to be turned on simultaneously and forming an intensity distribution of the position detection light in the Z-axis direction.

### Detailed Configuration of Optical Position Detector

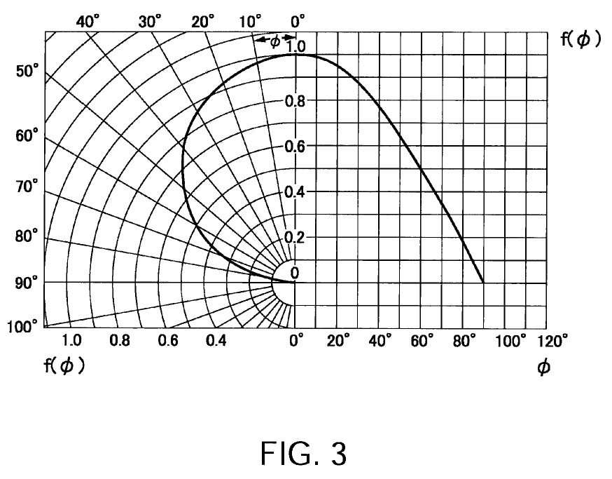

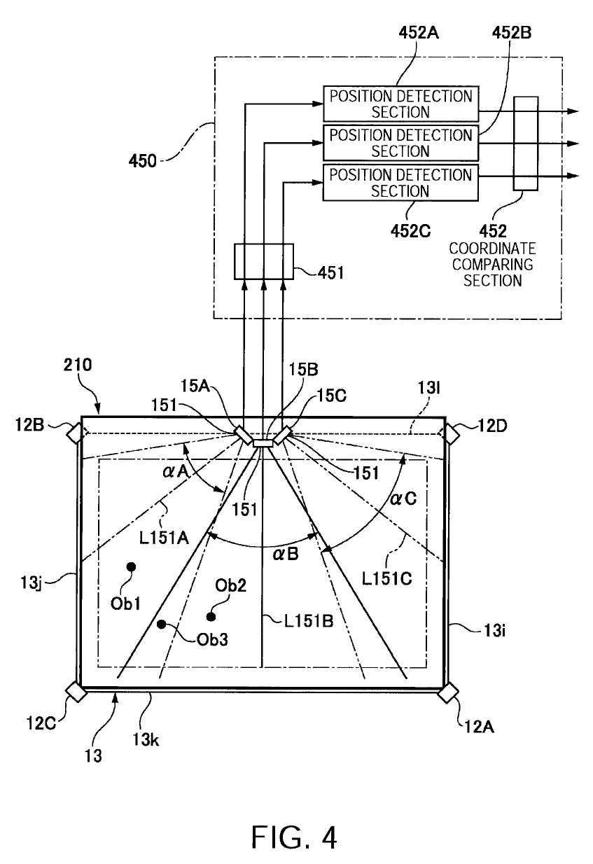

FIG. 3 is a graph showing the sensitivity directivity of the photodiode used for the light detector 15 in the optical position detector 10 to which the invention is applied. FIG. 4 is an explanatory view showing the configuration of the light detector 15 and the signal processing unit used for the optical position detector and the display device with a position detection function to which the invention is applied.

The light detector 15 shown in FIGS. 1A to 2B includes photodiodes as light-receiving elements. The photodiode has sensitivity directivity shown in FIG. 3. FIG. 3 shows the relation between an angle Φ formed relative to the central optical axis of the light detector 15 and a sensitivity f(Φ), where the sensitivity f(Φ) on the side of the central optical axis (front) of the light detector 15 is 1. As shown in FIG. 3, the sensitivity f(Φ) of the light detector 15 is maximum on the side of the central optical axis (front); as the angle Φ formed relative to the central optical axis of the light detector 15 increases, the sensitivity f(Φ) decreases; and the sensitivity f(Φ) is 0 in an angular direction of 90° relative to the central optical axis. In this case, in an angle range where the angle Φ formed relative to the central optical axis of the light detector 15 is 30° or less on one side (angle range of 60° with the central optical axis as a center), the sensitivity f(Φ) is 0.87 or more. In such a high-sensitivity angle range, the position detection described with reference to FIGS. 2A to 2C can be performed accurately. On the other hand, when the angle Φ formed relative to the central optical axis of the light detector 15 exceeds 30° on one side, the sensitivity f(Φ) decreases. In such an angle range, detection error increases.

In the embodiment, therefore, the plurality of light detectors with their central optical axes directed to different areas of the detection area 10R are disposed as the light detector 15 as shown in FIGS. 1A and 1B, 2A and 2B, and 4, and a high-sensitivity angle range of each of the plurality of light detectors 15 is used for position detection. In the embodiment, the three light detectors 15A, 15B, and 15C are used as the plurality of light detectors 15. In FIG. 4, the central optical axes of the light detectors 15A, 15B, and 15C are indicated by a dashed-dotted line L151A, a solid line L151B, and a dashed-two dotted line L151C, respectively.

In this case, the three light detectors 15A, 15B, and 15C are arranged at a specified place (specified place adjacent to the side portion 13l of the light guide plate 13) adjacent to the side portion of the detection area 10R with their central optical axes directed to different angular directions from one another. The three light detectors 15A, 15B, and 15C are arranged so that the central optical axes are equally angularly spaced. In the embodiment, the angle formed by the central optical axes of the neighboring light detectors 15A, 15B, and 15C is 60° or substantially 60°. Also in the embodiment, in view of the sensitivity directivity described with reference to FIG. 3, the high-sensitivity angle range (angle range in which the sensitivity f(Φ) is high) of 60° with the central optical axis as a center is used in each of the light detectors 15A, 15B, and 15C. That is, the high-sensitivity angle ranges of the light detectors 15A, 15B, and 15C are indicated by αA, αB, and αC, respectively, in FIG. 4. Substantially the entire detection area 10R is covered with the high-sensitivity angle ranges αA, αB, and αC of the light detectors 15A, 15B, and 15C. In the example shown in FIG. 4, although portions of the detection area 10R are not covered with the high-sensitivity angle ranges αA, αB, and αC of the light detectors 15A, 15B, and 15C, input operation is not performed in the portions, causing no trouble. For covering the entire detection area 10R with the high-sensitivity angle ranges αA, αB, and αC of the light detectors 15A, 15B, and 15C, the light detectors 15A, 15B, and 15C are arranged away from the detection area 10R.

### Detailed Configuration of Light Detector 15

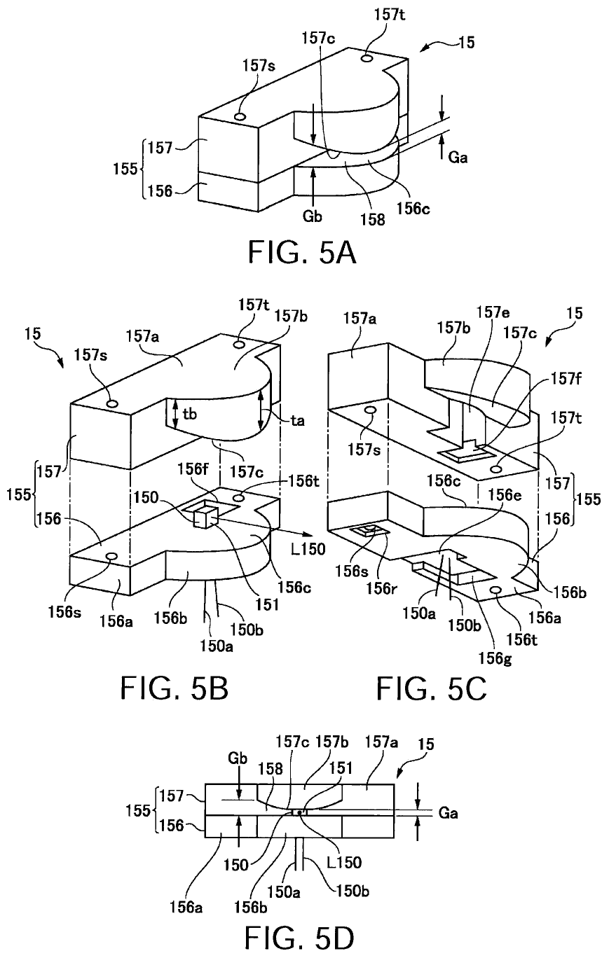

FIGS. 5A to 5D are explanatory views of the light detector 15 used for the optical position detector and the display device with a position detection function to which the invention is applied, in which FIG. 5A is a perspective view of the light detector 15; FIG. 5B is an exploded perspective view of the light detector 15 as viewed from an upper perspective; FIG. 5C is an exploded perspective view of the light detector 15 as viewed from a lower perspective; and FIG. 5D is an elevation view of the light detector 15.

In the embodiment, based on the sensitivity directivity shown in FIG. 3, position detection is performed based on the result of light received in the high-sensitivity angle ranges αA, αB, and αC of the light detector 15. As will be understood from FIG. 3, however, the sensitivity f(Φ) varies in a range of from 1 to 0.87 even in the high-sensitivity angle ranges αA, αB, and αC (range of 30° on one side).

In the embodiment, therefore, as shown in FIGS. 5A to 5D, the light detector 15 includes a light-receiving element 150 (photodiode) including the light-receiving portion 151 and a directivity adjusting member 155 that reduces the difference between an incident light amount on a central optical axis L150 side of the light-receiving element 150 and an incident light amount in an angular direction away from the central optical axis. In the embodiment, the directivity adjusting member 155 includes a first light shielding member 156 formed of a black resin molded article and a second light shielding member 157 formed of a black resin molded article interposing the light-receiving element 150 between the first light shielding member 156 and the second light shielding member 157. The directivity adjusting member 155 (the first light shielding member 156 and the second light shielding member 157) causes a light incident opening to become narrower on the central optical axis L150 side of the light-receiving element 150 than in an angular direction away from the central optical axis L150.

More specifically, in the directivity adjusting member 155 as shown in FIGS. 5A and 5D, the first light shielding member 156 and the second light shielding member 157 form as a light incident opening a slit 158 that extends from the central optical axis L150 side of the light-receiving element 150 to both sides in a circumferential direction. A width dimension Ga of the slit 158 on the central optical axis L150 side is narrower than a width dimension Gb in an angular direction away from the central optical axis L150.

For configuring the directivity adjusting member 155 having such a configuration, the first light shielding member 156 includes a substantially rectangular parallelepiped base 156a that holds two lead wires 150a and 150b of the light-receiving element 150 and a half-disc-shaped light shielding portion 156b that protrudes forward from the front surface of the base 156a. Similarly to the first light shielding member 156, the second light shielding member 157 includes a substantially rectangular parallelepiped base 157a and a half-disc-shaped light shielding portion 157b that protrudes forward from the front surface of the base 157a.

In this case, the light-receiving element 150 protrudes at the base 156a of the first light shielding member 156 on the surface side overlapping the second light shielding member 157. In the second light shielding member 157, a recess 157e is formed at a portion overlapping the light-receiving element 150, and the recess 157e is open at its front. Therefore, the first light shielding member 156 and the second light shielding member 157 can be overlapped so that the bases 156a and 157a overlap, and the light-receiving portion 151 of the light-receiving element 150 is open to the outside via the recess 157e in a state where the first light shielding member 156 and the second light shielding member 157 are overlapped.

Holes 156s and 157s in communication with each other are formed in one end portions of the bases 156a and 157a, respectively, and holes 156t and 157t in communication with each other are formed in the other end portions of the bases 156a and 157a, respectively. Therefore, by threaded engagement at the holes 156s and 157s and threaded engagement at the holes 156t and 157t, the first light shielding member 156 and the second light shielding member 157 can be coupled. Moreover, the bases 156a and 157a may be adhesively fixed to each other to couple the first light shielding member 156 with the second light shielding member 157. Here, the forming region of the hole 156s is a recess 156r in the base 156a.

In the thus configured directivity adjusting member 155, when the first light shielding member 156 and the second light shielding member 157 are coupled, the slit 158 is formed in an angle range of about 180° between the light shielding portion 156b and the light shielding portion 157b. The light-receiving portion 151 of the light-receiving element 150 is positioned at the back of the slit 158. In this case, since the light shielding portion 156b of the first light shielding member 156 has a constant thickness, an inner surface 156c on the side where the slit 158 is positioned in the light shielding portion 156b is a surface parallel to the central optical axis L150 of the light-receiving element 150. On the other hand, in the light shielding portion 157b of the second light shielding member 157, an outer surface on the opposite side to the side where the slit 158 is positioned is a surface parallel to the central optical axis L150 of the light-receiving element 150, but an inner surface 157c on the side where the slit 158 is positioned is a tapered surface. Therefore, a thickness ta of the light shielding portion 157b on the central optical axis L150 side is greater than a thickness tb in an angular direction away from the central optical axis L150. Therefore, the width dimension Ga of the slit 158 on the central optical axis side is narrower than the width dimension Gb in the angular direction away from the central optical axis. In this case, the width dimension of the slit 158 continuously expands from the side where the central optical axis L150 is positioned to both the end portions in the circumferential direction, which cancels out variations in the sensitivity f(Φ) in the light detector 15. For example, the width dimension of the slit 158 at each angular position is the inverse of the sensitivity f(Φ). For the width dimension of the slit 158, a configuration may be employed in which the width dimension expands stepwise from the side where the central optical axis L150 is positioned toward both end portions in the circumferential direction. Moreover, the light detector 15 is used in a range of 30° on one side, but the slit 158 is formed in a range of 90° on one side.

In the thus configured light detector 15, the sensitivity f(Φ) varies in the range of from 1 to 0.87 in an angle range of 30° on one side with the light-receiving element 150 alone. However, when the light-receiving element 150 is combined with the directivity adjusting member 155, the light incident opening is narrower on the central optical axis L150 side of the light-receiving element 150 than in an angular direction away from the central optical axis L150. Therefore, the sensitivity f(Φ) in a range of 30° on one side is constant. That is, in the light detector 15, the sensitivity f(Φ) is adjusted to the sensitivity (=0.87) at an angle of 30° shown in FIG. 3 in the entire range of 30° on one side. Accordingly, in the light detectors 15A, 15B, and 15C shown in FIG. 4, the sensitivity f(Φ) is equal in the entire high-sensitivity angle ranges αA, αB, and αC each of which is the range of 30° on one side.

A recess 156e is formed in the bottom of the first light shielding member 156 of the embodiment. At an end portion of the recess 156e, a groove-like through hole 156g penetrating through the base 156a is formed. In the surface overlapping the second light shielding member 157 in the base 156a, a portion where the groove-like through hole 156g is open serves as a recess 156f. At a portion overlapping the recess 156f in the second light shielding member 157, a recess 157f is formed. Further, the recess 157f is communicated with the recess 157e into which the light-receiving element 150 is accommodated. Therefore, in the directivity adjusting member 155 shown in FIGS. 5A to 5D, when the light-receiving element 150 is used in a state of being surface-mounted on a flexible wiring board (not shown), the flexible wiring board can be extended to the outside through the recesses 156f and 157f and the groove-like through hole 156g.

### Specific Configuration of Signal Processing Unit

Again in FIG. 4, the detection results by the light detectors 15A, 15B, and 15C are output to a signal processing unit 450 in the embodiment. In the embodiment, the signal processing unit 450 includes a received-light intensity-determining section 451 that determines absolute magnitude of received-light intensities by the three light detectors 15A, 15B, and 15C, and three position detection sections 152A, 152B, and 152C that detect a position of the target object Ob in the detection area 10R based on the received-light result by the three light detectors 15A, 15B, and 15C. In this case, the received-light intensity-determining section 451 compares between the received-light intensities by the three light detectors 15A, 15B, and 15C and a predetermined threshold value, and outputs only a received-light intensity equal to or greater than the threshold value among the received-light intensities by the light detectors 15A, 15B, and 15C to the position detection sections 152A, 152B, and 152C. Therefore, any of the three light detectors 15A, 15B, and 15C detects the position of the target object Ob based only on the received-light result by a light detector determined as having a higher received-light intensity in the determination result by the received-light intensity-determining section 451 and outputs the detection result.

In the embodiment, the signal processing unit 450 also includes a coordinate comparing section 453. The coordinate comparing section 453 compares the position detection results (XY coordinates) output from the position detection sections 152A, 152B, and 152C and outputs the position detection results (XY coordinates) output from the position detection sections 152A, 152B, and 152C when the detected positions are away. On the other hand, when there are coordinates close to each other in the position detection results (XY coordinates) output from the position detection sections 152A, 152B, and 152C, the coordinate comparing section 453 assumes the coordinates as the same coordinates and outputs, for example, values obtained by averaging the coordinates close to each other.

### Operation

In the optical position detector 10 of the embodiment, the position-detecting light sources 12A and 12D and the position-detecting light sources 12B and 12C are driven out of phase, and the ratio or difference between the detected values by the light detector 15 during the driving is used to detect the X coordinate of the target object Ob in the detection area 10R. Moreover, the position-detecting light sources 12A and 12C and the position-detecting light sources 12B and 12D are driven out of phase, and the ratio or difference between the detected values by the light detector 15 during the driving is used to detect the Y coordinate of the target object Ob in the detection area 10R. At the time of such a detection, the signal processing unit 450 shown in FIG. 4 can improve the position detection accuracy and perform multi-position detection as will be described below.

For example, it is assumed that the target object Ob is present at a position indicated as a point Ob1 in FIG. 4. In this case, the position detection light reflected by the target object Ob at the position indicated as the point Ob1 is received by the three light detectors 15A, 15B, and 15C. Here, the target object Ob is within the high-sensitivity angle range αA of the light detector 15A but is out of the high-sensitivity angle ranges αB and αC of the light detectors 15B and 15C. Therefore, received-light intensities by the three light detectors 15A, 15B, and 15C are in the following relation.

light detector 15B<light detector 15C<threshold value<light detector 15A

Accordingly, the received-light intensity-determining section 451 outputs only the detection result of the light detector 15A among the detection results of the light detectors 15A, 15B, and 15C to the position detection section 152A. Accordingly, only coordinates detected by the position detection section 152A are output.

It is assumed that the target object Ob is present at a position indicated as a point Ob2 in FIG. 4. In this case, the position detection light reflected by the target object Ob at the position indicated as the point Ob2 is received by the three light detectors 15A, 15B, and 15C, but the target object Ob is within the high-sensitivity angle range αB of the light detector 15B. Therefore, received-light intensities by the three light detectors 15A, 15B, and 15C are in the following relation.

light detector 15C<light detector 15A<threshold value<light detector 15B

Accordingly, the received-light intensity-determining section 451 outputs only the detection result of the light detector 15B among the detection results of the light detectors 15A, 15B, and 15C to the position detection section 152B. Accordingly, only coordinates detected by the position detection section 152B are output.

On the other hand, it is assumed that the target object Ob is present at a position indicated as a point Ob3 in FIG. 4. In this case, the target object Ob at the position indicated as the point Ob3 is within both the high-sensitivity angle ranges αA and αB of the light detector 15A and the light detector 15B. Therefore, received-light intensities by the three light detectors 15A, 15B, and 15C are in the following relation.

light detector 15C<threshold value<light detector 15B<light detector 15A

Accordingly, the received-light intensity-determining section 451 outputs the detection results of the light detectors 15A and 15B among the detection results of the light detectors 15A, 15B, and 15C to the position detection sections 152A and 152B. Accordingly, coordinates are output from both the position detection sections 152A and 152B. In this case, the coordinate comparing section 453 compares the position detection results (XY coordinates) output from the position detection sections 152A and 152B. In this case, the coordinate comparing section 453 assumes the detection results as the position of one target object Ob because the detected positions are close to each other and outputs average values of the position detection results (XY coordinates) output from the position detection sections 152A and 152B.

Also in the embodiment, it is assumed that the target object Ob is present at both the position indicated as the point Ob1 and the position indicated as the point Ob2 in FIG. 4. In this case, the target object Ob at the position indicated as the point Ob1 is present in the high-sensitivity angle range αA of the light detector 15A, while the target object Ob at the position indicated as the point Ob2 is present in the high-sensitivity angle range αB of the light detector 15B. Therefore, received-light intensities by the three light detectors 15A, 15B, and 15C are in the following relation.

light detector 15C<threshold value<light detector 15B≅light detector 15A

Accordingly, the received-light intensity-determining section 451 outputs the detection results of the light detectors 15A and 15B among the detection results of the light detectors 15A, 15B, and 15C to the position detection sections 152A and 152B. Accordingly, coordinates are output from both the position detection sections 152A and 152B. In this case, the coordinate comparing section 453 outputs the respective position detection results (XY coordinates) output from the position detection sections 152A and 152B because the detected positions are away from each other. Accordingly, when the target object Ob is present at both the position indicated as the point Ob1 and the position indicated as the point Ob2 in FIG. 4, the coordinates of the point Ob1 and the coordinates of the point Ob2 are output.

### Modified Example of Signal Processing Unit 450

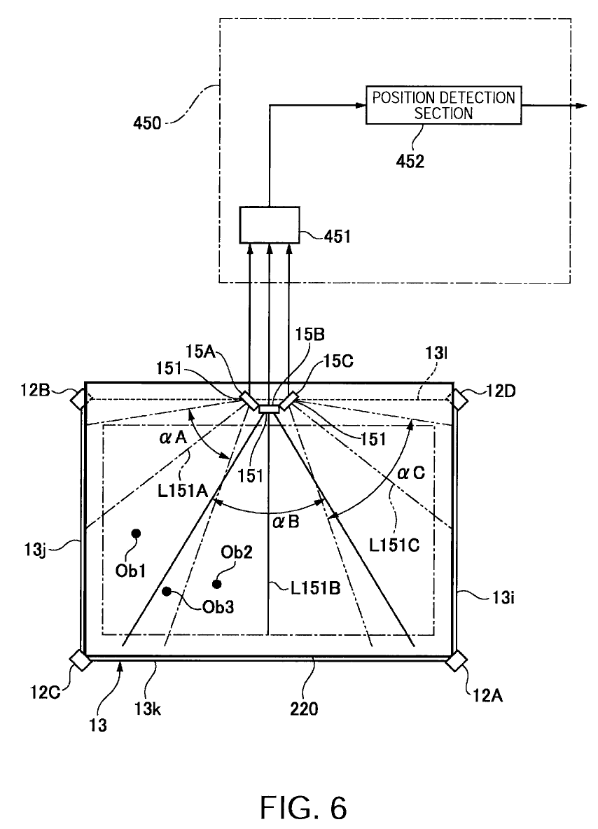

FIG. 6 is an explanatory view showing a modified example of the signal processing unit 450 used for the optical position detector 10 to which the invention is applied. In the signal processing unit 450 shown in FIG. 4, the position of the target object Ob is detected based on the received-light result by the light detector determined as having a received-light intensity greater than the threshold value in the determination result by the received-light intensity-determining section 451. On the other hand, in the signal processing unit 450 shown in FIG. 6, the received-light intensity-determining section 451 outputs a relatively highest received-light intensity among the received-light intensities by the three light detectors 15A, 15B, and 15C to a position detection section 452. Other configurations are the same as those described with reference to FIG. 4.

In the case of such a configuration, when the target object Ob is present at the position indicated as the point Ob3 in FIG. 4, received-light intensities by the three light detectors 15A, 15B, and 15C are in the following relation.

light detector 15C<light detector 15B<light detector 15A

Accordingly, the received-light intensity-determining section 451 outputs only the detection result of the light detector 15A among the detection results of the light detectors 15A, 15B, and 15C to the position detection section 452. Accordingly, only coordinates detected based on the received-light result by the light detector 15A are output from the position detection section 452.

### Main Effect of Embodiment

As described above, in the optical position detector 10 and the display device with a position detection function 100 of the embodiment, when the position detection lights L2a to L2d exit from the light exiting surface 13s of the light guide plate 13 and is reflected by the target object Ob arranged on the light exiting side of the light guide plate 13, the reflected light is detected by the light detector 15. In this case, since the intensity of the position detection lights L2a to L2d and the distance from the position-detecting light sources 12A to 12D in the detection area 10R have a certain correlativity, the XY coordinates of the target object Ob can be detected based on the received-light intensity obtained through the light detector 15. According to such a detection system, since it is sufficient to form the light intensity distribution of the position detection light on the one surface 220s side of the screen member 220, the light guide plate 13 is not necessarily arranged on the front side of the screen member 220. Therefore, the detection system is suitable for configuring the display device with a position detection function 100 of the type that displays an image on the screen member 220.

In the embodiment, the three light detectors 15 (the light detectors 15A, 15B, and 15C) are used, and the three light detectors 15 have central optical axes directed to different areas from one another of the detection area 10R. Accordingly, even when the light detector 15 has sensitivity directivity, the detection area 10R can be covered only with the respective high-sensitivity angle ranges of the three light detectors 15. Therefore, even when position detection is performed utilizing the intensity distribution of the position detection light within the detection area 10R, the position detection is less subject to the sensitivity directivity of the light detector 15. Accordingly, the position detection can be performed with high accuracy.

In the embodiment, the three light detectors 15A, 15B, and 15C are arranged at the specified place adjacent to the side portion of the detection area 10R with their central optical axes directed to different angular directions from one another. Therefore, the plurality of light detectors 15A, 15B, and 15C can be arranged within the narrow space around the detection area 10R. Since the three light detectors 15A, 15B, and 15C are arranged such that the central optical axes are equally angularly spaced, the high-sensitivity angle ranges of the three light detectors 15A, 15B, and 15C can be effectively utilized.

Further, the light detector 15 includes the directivity adjusting member 155 that reduces the difference between the incident light amount on the central optical axis side of the light-receiving element 150 and the incident light amount in an angular direction away from the central optical axis. Therefore, even if sensitivity directivity exists within the high-sensitivity angle range utilized by the light detector 15, since the sensitivity directivity can be moderated by the directivity adjusting member 155, the position detection accuracy can be enhanced.

The directivity adjusting member 155 includes two light shielding members (the first light shielding member 156 and the second light shielding member 157) that cause the light incident opening to become narrower on the central optical axis side of the light-receiving element 150 than in an angular direction away from the central optical axis. Therefore, with such a simple configuration that the size of the light incident opening is increased or decreased, since the sensitivity directivity within the angle range utilized as the high-sensitivity angle range in the light detector 15 can be moderated, the position detection accuracy can be enhanced. Further, the first light shielding member 156 and the second light shielding member 157 include as the light incident opening the slit 158 that extends from the central optical axis side of the light-receiving element 150 toward the angular direction side away from the central optical axis. Therefore, since the sensitivity directivity within the high-sensitivity angle range utilized in the light detector 15 can be effectively canceled out by changing the slit width continuously or stepwise, the position detection accuracy can be enhanced.

### Configuration of Another Position-Detecting Light Source Unit

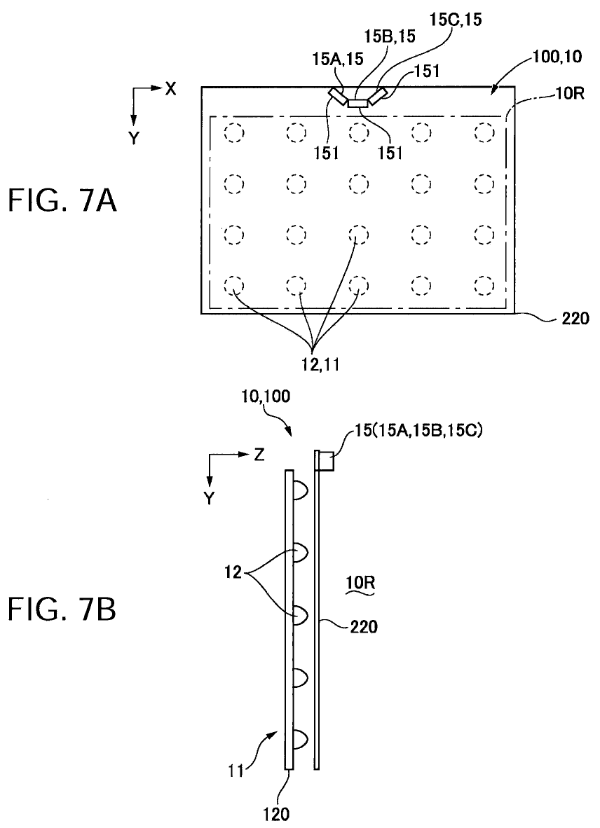

FIGS. 7A and 7B are explanatory views of another position-detecting light source unit 11 used for the optical position detector 10 to which the invention is applied. In the above-described embodiment, the light guide plate 13 is used as the position-detecting light source unit 11. As shown in FIGS. 7A and 7B, however, a position-detecting light source unit 11 having a configuration without a light guide plate may be employed in which, on a back surface side of a screen member 210, a substrate 120 on which the plurality of position-detecting light sources 12 are arranged at positions facing the detection area 10R in the Z-axis direction is disposed.

Also in such a configuration, in the case of detecting the X-coordinate position of the target object Ob, when only the position-detecting light sources 12 on one side away in the X-direction are turned on among the plurality of position-detecting light sources 12, the intensity distribution of the position detection light can be formed. In the case of detecting the Y-coordinate position of the target object Ob, when only the position-detecting light sources 12 on one side away in the Y-direction are turned on among the plurality of position-detecting light sources 12, the intensity distribution of the position detection light can be formed.

### Another Layout Example of Light Detector 15

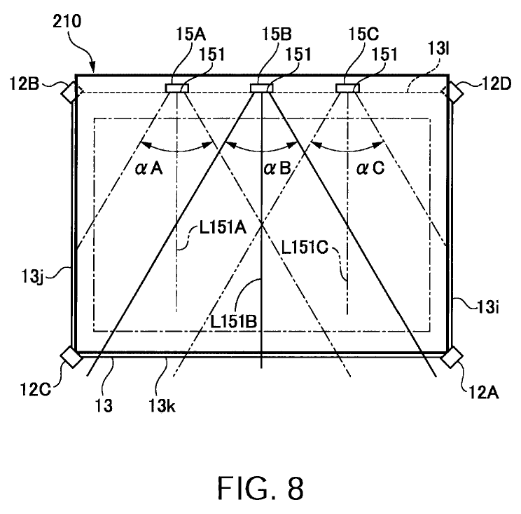

FIG. 8 is an explanatory view showing another layout of the light detector 15 in the optical position detector 10 to which the invention is applied. In the above-described embodiment, the three light detectors 15A, 15B, and 15C are arranged at the specified place adjacent to the side portion of the detection area 10R with their central optical axes directed to different angular directions from one another. In the example, however, as shown in FIG. 8, the three light detectors 15A, 15B, and 15C are arranged in an area adjacent to one side portion (side portion along the side portion 13l of the light guide plate 13) of the detection area 10R at positions shifted in the extending direction of the side portion with their central optical axes directed in a direction parallel to one another. More specifically, the three light detectors 15A, 15B, and 15C are spaced equally in the long side direction of the detection area 10R (the image display area 20R), and the central optical axes of the light detectors 15A, 15B, and 15C extend in a direction orthogonal to the side portions 13k and 13l of the light guide plate 13. Also in such a configuration, the entire or substantially entire detection area 10R can be covered with the high-sensitivity areas of the three light detectors 15A, 15B, and 15C. Accordingly, the position detection accuracy is high.

### Other Embodiments

In the above-described embodiment, the optical position detector 10 using the three light detectors 15 (the light detectors 15A, 15B, and 15C) is illustrated. However, two light detectors 15 or four or more light detectors 15 may be used.

In the above-described embodiment, the invention is applied to the landscape-oriented screen member 220. However, the invention may be applied to the case where a portrait-oriented screen member 220 is used. In the above-described embodiment, the position-detecting light source unit 11 is arranged on the other surface 220t side of the screen member 220. However, the position-detecting light source unit 11 may be arranged on the one surface 220s side of the screen member 220.

In the above-described embodiment, the invention is applied to a screen unit used for a projection type display device. However, the invention may be applied to a screen unit used for an electronic blackboard.

Modified Examples of Display Device with Position Detection Function 100

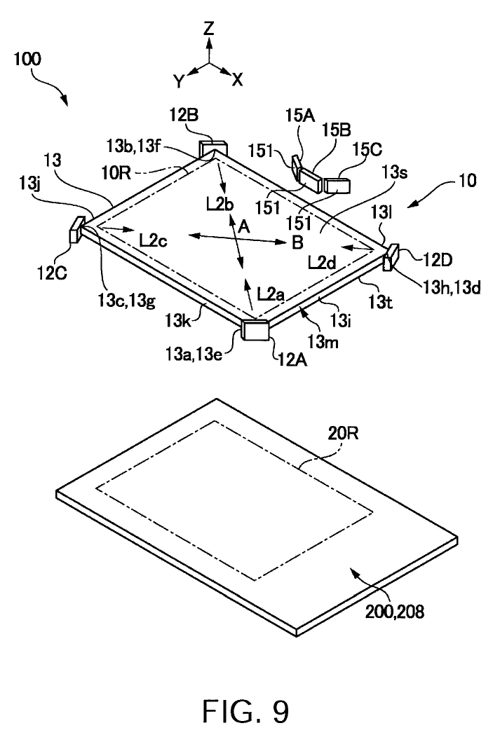

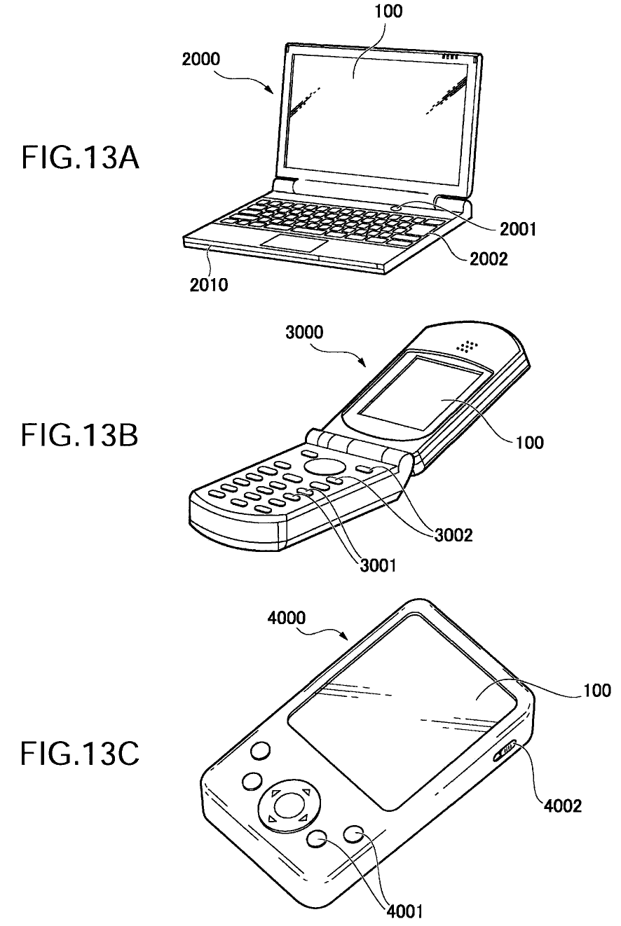

In the above-described embodiment, the display device with a position detection function 100 is applied to a projection type display device or an electronic blackboard. However, as shown in FIGS. 9 to 12B, the display device with a position detection function 100 can be used for electronic apparatuses which will be described later with reference to FIGS. 13A to 13C by employing a direct-view type display device as the image forming device 200.

First Modified Example of Display Device with Position Detection Function 100

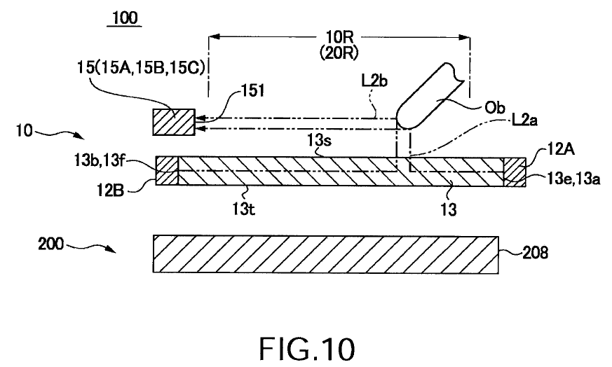

FIGS. 9 and 10 are an exploded perspective view and an explanatory view showing a cross-sectional configuration, respectively, of the optical position detector 10 and the display device with a position detection function 100 according to a first modified example of the invention. In the display device with a position detection function 100 of the first modified example, since the optical position detector 10 has the same configuration as that of the above-described embodiment, the common parts are denoted by the same reference numerals and signs, and the description thereof is omitted.

The display device with a position detection function 100 shown in FIGS. 9 and 10 includes the optical position detector 10 and the image forming device 200. The optical position detector 10 includes the position-detecting light source 12 that emits a position detection light, the light guide plate 13, and the light detector 15 (the light detectors 15A, 15B, and 15C) with the light-receiving portion 151 directed to the detection area 10R. The image forming device 200 is a direct-view type display device 208 such as an organic electroluminescence device or a plasma display device and is disposed on the opposite side to the input operation side with respect to the optical position detector 10. The direct-view type display device 208 includes the image display area 20R in an area overlapping the light guide plate 13 in plan view. The image display area 20R overlaps the detection area 10R in plan view.

Second Modified Example of Display Device with Position Detection Function 100

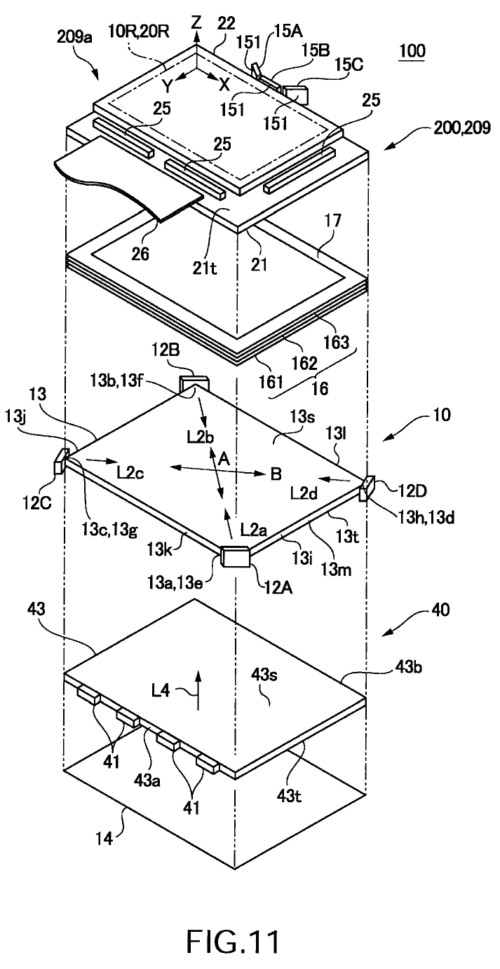

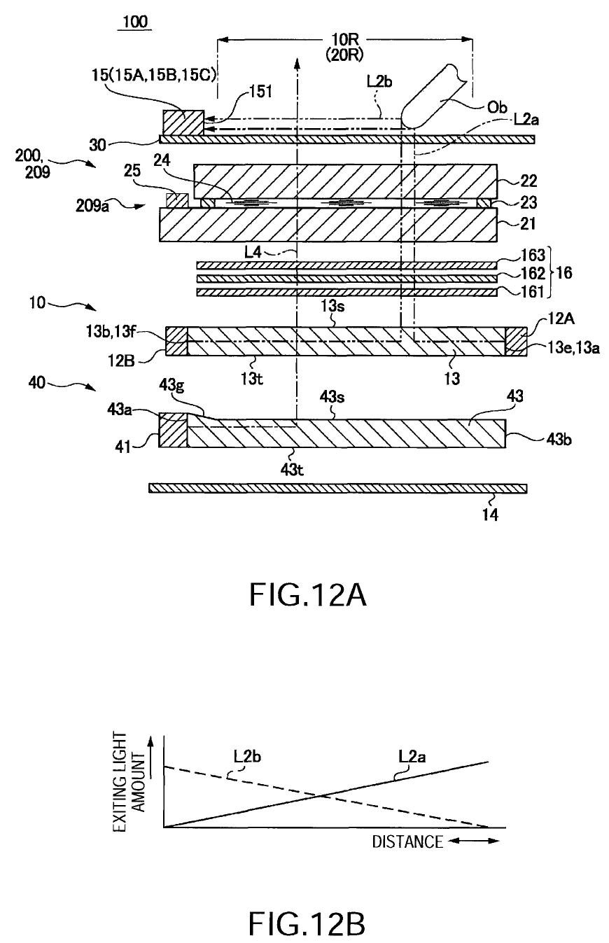

FIGS. 11 to 12B are explanatory views and a graph of the optical position detector 10 and the display device with a position detection function 100 according to a second modified example of the invention, in which FIG. 11 is an exploded perspective view of the optical position detector 10 and the display device with a position detection function 100; and FIGS. 12A and 12B are an explanatory view showing the cross-sectional configuration of the same and a graph, respectively. In the display device with a position detection function 100 of the second modified example, the optical position detector 10 has the same configuration as that of the above-described embodiment, the common parts are denoted by the same reference numerals and signs, and the description thereof is omitted.

The display device with a position detection function 100 shown in FIGS. 11 and 12A includes the optical position detector 10 and the image forming device 200. The optical position detector 10 includes the position-detecting light source 12 that emits a position detection light, the light guide plate 13, and the light detector 15 (the light detectors 15A, 15B, and 15C) with the light-receiving portion 151 directed to the detection area 10R. The image forming device 200 includes a liquid crystal device 209 that is a direct-view type display device and a light-transmissive cover member 30. The liquid crystal device 209 includes the image display area 20R in an area overlapping the light guide plate 13 in plan view. The image display area 20R overlaps the detection area 10R in plan view.

In the display device with a position detection function 100 of the second modified example, an optical sheet 16 for equalizing the position detection lights L2a to L2d is arranged as necessary on the light exiting side of the light guide plate 13. In the second modified example, as the optical sheet 16, a first prism sheet 161 facing the light exiting surface 13s of the light guide plate 13, a second prism sheet 162 facing the first prism sheet 161 on the opposite side to the side where the light guide plate 13 is positioned, and a light scatter 163 facing the second prism sheet 162 on the opposite side to the side where the light guide plate 13 is positioned are used. A rectangular frame-shaped light shielding sheet 17 is arranged around the optical sheet 16 on the opposite side to the side where the light guide plate 13 is positioned with respect to the optical sheet 16. The light shielding sheet 17 prevents the position detection lights L2a to L2d emitted from the position-detecting light sources 12A to 12D from leaking.

The liquid crystal device 209 (the image forming device 200) includes a liquid crystal panel 209a on the opposite side to the side where the light guide plate 13 is positioned with respect to the optical sheet 16 (the first prism sheet 161, the second prism sheet 162, and the light scatter 163). In the second modified example, the liquid crystal panel 209a is a transmissive liquid crystal panel having a structure in which two light-transmissive substrates 21 and 22 are bonded together with a sealing material 23 and liquid crystals 24 are filled between the substrates. In the second modified example, the liquid crystal panel 209a is an active matrix type liquid crystal panel in which light-transmissive pixel electrodes, data lines, scanning lines, pixel switching elements (all not shown) are formed on one of the two light-transmissive substrates 21 and 22, and light-transmissive common electrodes (not shown) are formed on the other substrate. Pixel electrodes and a common electrode are sometimes formed on an identical substrate. In the liquid crystal panel 209a, when a scanning signal is output to each of pixels via the scanning line, and an image signal is output via the data line, the orientation of the liquid crystals 24 are controlled in each of the plurality of pixels. As a result, an image is formed on the image display area 20R.

In the liquid crystal panel 209a, on one light-transmissive substrate 21, a substrate extended portion 21t extending peripherally from the outline of the other light-transmissive substrate 22 is disposed. On a surface of the substrate extended portion 21t, electronic components 25 constituting a drive circuit and the like are mounted. A wiring member 26 such as a flexible wiring board or a flexible printed circuit (FPC) is connected to the substrate extended portion 21t. Here, only the wiring member 26 may be mounted on the substrate extended portion 21t. As necessary, a polarizer (not shown) is arranged on the outer surface sides of the light-transmissive substrates 21 and 22.

For detecting the planar position of the target object Ob in this case, the position detection lights L2a to L2d have to be emitted to the viewing side where operation is performed by the target object Ob. Therefore, the liquid crystal panel 209a is arranged closer to the viewing side (operation side) than the light guide plate 13 and the optical sheet 16. Accordingly, in the liquid crystal panel 209a, the image display area 20R is configured to be able to transmit the position detection lights L2a to L2d. When the liquid crystal panel 209a is arranged on the opposite side to the viewing side of the light guide plate 13, the image display area 20R does not have to be configured so as to transmit the position detection lights L2a to L2d. Instead, the image display area 20R has to be configured so as to be visible from the viewing side through the light guide plate 13.

The liquid crystal device 209 includes an illumination unit 40 for illuminating the liquid crystal panel 209a. In the second modified example, the illumination unit 40 is arranged between the light guide plate 13 and a reflector 14 on the opposite side to the side where the liquid crystal panel 209a is positioned with respect to the light guide plate 13. The illumination unit 40 includes illuminating light sources 41 and an illuminating light guide plate 43 that causes the illumination light emitted from the illuminating light source 41 to propagate therethrough and exit therefrom. The illuminating light guide plate 43 has a rectangular planar shape. The illuminating light source 41 includes, for example, a light-emitting element such as a light-emitting diode (LED), and emits, for example, a white illumination light L4 in response to a drive signal output from the drive circuit (not shown). In the second modified example, the illuminating light sources 41 are arranged in plural numbers along a side portion 43a of the illuminating light guide plate 43.

The illuminating light guide plate 43 is provided with an inclined surface 43g at a surface portion (outer peripheral portion of a light exiting surface 43s on the side portion 43a side) on a light exiting side adjacent to the side portion 43a. The illuminating light guide plate 43 gradually increases in thickness toward the side portion 43a. With the light incident structure having the inclined surface 43g, the height of the side portion 43a is adjusted to the height of the light exiting surface of the illuminating light source 41 while suppressing an increase in thickness of a portion where the light exiting surface 43s is disposed.

In the illumination unit 40, the illumination light emitted from the illuminating light source 41 is incident from the side portion 43a of the illuminating light guide plate 43 to the inside of the illuminating light guide plate 43, thereafter propagates through the inside of the illuminating light guide plate 43 toward an outer edge portion 43b on the opposite side, and exits from the light exiting surface 43s as one surface. In this case, the illuminating light guide plate 43 has a light guide structure in which the light amount ratio of the exiting light from the light exiting surface 43s to the internal propagation light monotonously increases from the side portion 43a side toward the outer edge portion 43b on the opposite side. Such a light guide structure can be realized by, for example, gradually increasing the area of a refracting surface having microscopic asperities for light deflection or light scattering, or the forming density of a printed scattering layer, formed on the light exiting surface 43s or a back surface 43t of the illuminating light guide plate 43 toward the internal propagation direction. By providing the light guide structure, the illumination light L4 incident from the side portion 43a exits from the light exiting surface 43s substantially equally.

In the second modified example, the illuminating light guide plate 43 is arranged on the opposite side to the viewing side of the liquid crystal panel 209a so as to overlap the image display area 20R of the liquid crystal panel 209a in a planar manner and functions as the so-called backlight. However, the illuminating light guide plate 43 may be configured so as to function as the so-called frontlight by arranging it on the viewing side of the liquid crystal panel 209a. In the second modified example, the illuminating light guide plate 43 is arranged between the light guide plate 13 and the reflector 14. However, the illuminating light guide plate 43 may be arranged between the optical sheet 16 and the light guide plate 13. The illuminating light guide plate 43 and the light guide plate 13 may be configured as a common light guide plate. Also in the second modified example, the optical sheet 16 is shared between the position detection lights L2a to L2d and the illumination light L4. However, a dedicated optical sheet different from the optical sheet 16 may be arranged on the light exiting side of the illuminating light guide plate 43. This reason is as follows. In many cases, a light scatter exhibiting a sufficient light scattering effect is used in the illuminating light guide plate 43 for equalizing the planar brightness of the illumination light L4 exiting from the light exiting surface 43s. In the position-detecting light guide plate 13, however, the large scattering of the position detection lights L2a to L2d exiting from the light exiting surface 13s hinders position detection. Therefore, since a light scatter does not have to be disposed, or a light scatter exhibiting a relatively mild light scattering effect has to be used, a light scatter dedicated for the illuminating light guide plate 43 is preferably used. However, an optical sheet having a light condensing effect, such as a prism sheet (the first prism sheet 161 or the second prism sheet 162), may be shared.

### Example of Mounting on Electronic Apparatuses

With reference to FIGS. 13A to 13C, electronic apparatuses to which the display device with a position detection function 100 described with reference to FIGS. 9 to 12B is applied will be described. FIGS. 13A to 13C are explanatory views of electronic apparatus using the display device with a position detection function according to the invention. FIG. 13A shows the configuration of a mobile personal computer including the display device with a position detection function 100. The personal computer 2000 includes the display device with a position detection function 100 as a display unit and a main body 2010. The main body 2010 is provided with a power switch 2001 and a keyboard 2002. FIG. 13B shows the configuration of a mobile phone including the display device with a position detection function 100. The mobile phone 3000 includes a plurality of operation buttons 3001, scroll buttons 3002, and the display device with a position detection function 100 as a display unit. An image displayed on the display device with a position detection function 100 is scrolled by operating the scroll buttons 3002. FIG. 13C shows the configuration of a personal digital assistant (PDA) to which the display device with a position detection function 100 is applied. The PDA 4000 includes a plurality of operation buttons 4001, a power switch 4002, and the display device with a position detection function 100 as a display unit. When the power switch 4002 is operated, various types of information such as an address book and a schedule note are displayed on the display device with a position detection function 100.

Examples of electronic apparatuses to which the display device with a position detection function 100 is applied include not only the electronic apparatuses shown in FIGS. 13A to 13C but also digital still cameras, liquid crystal televisions, viewfinder type or direct-view monitor type video tape recorders, car navigation systems, pagers, electronic notebooks, calculators, word processors, workstations, videophones, POS terminals, and bank terminals. The above-described display device with a position detection function 100 is applicable as a display unit of the various kinds of electronic apparatuses.

The entire disclosure of Japanese Patent Application No. 2009-215380, filed Sep. 17, 2009 is expressly incorporated by reference herein.

What is claimed is:

1. An optical position detector for optically detecting a position of a target object within a detection area, comprising:
a position-detecting light source unit that emits a position detection light toward the detection area to form an intensity distribution of the position detection light in the detection area;
a plurality of light detectors with their central optical axes directed to different areas from each other within the detection area; and
a signal processing unit that detects a position of the target object based on the result of receiving, by the plurality of light detectors, the position detection light reflected by the target object in the detection area.

2. The optical position detector according to claim 1, wherein the plurality of light detectors are arranged at a specified place adjacent to a side portion of the detection area with the central optical axes directed in different angular directions from each other.

3. The optical position detector according to claim 2, wherein the plurality of light detectors include three or more light detectors with their central optical axes equally angularly spaced.

4. The optical position detector according to claim 1, wherein the plurality of light detectors are arranged in an identical side portion of the detection area at positions shifted in an extending direction of the side portion with the central optical axes directed in a direction parallel to each other.

5. The optical position detector according to claim 1, wherein the light detector includes a light-receiving element including a light-receiving portion, and a directivity adjusting member that reduces a difference between an incident light amount on a central optical axis side of the light-receiving element and an incident light amount in an angular direction away from the central optical axis.

6. The optical position detector according to claim 5, wherein the directivity adjusting member is a light shielding member that causes a light incident opening to become narrower on the central optical axis side of the light-receiving element than in an angular direction away from the central optical axis.

7. The optical position detector according to claim 6, wherein the light shielding member includes as the light incident opening a slit that extends from the central optical axis side of the light-receiving element toward an angular direction side away from the central optical axis, and
a width dimension of the slit on the central optical axis side is narrower than a width dimension of the slit in an angular direction away from the central optical axis.

8. The optical position detector according to claim 1, wherein the signal processing unit includes a received-light intensity-determining section that determines absolute magnitude of received-light intensities by the plurality of light detectors or relative magnitude of received-light intensities by the plurality of light detectors, and a position detection section that detects a position of the target object based on, of received-light results by the plurality of light detectors, a received-light result by a light detector determined as having a higher received-light intensity in the determination result by the received-light intensity-determining section.

9. A display device with a position detection function comprising the optical position detector according to claim 1, wherein
an image forming device that forms an image in an area overlapping the detection area is provided.
